(19) United States
(12) Patent Application Publication
(10) Pub. No.: US 2025/0198971 A1
(43) Pub. Date: Jun. 19, 2025

(54) PREPARATIVE CHROMATOGRAPH SYSTEM

(71) Applicant: SHIMADZU CORPORATION, Kyoto (JP)

(72) Inventors: Soichiro TAMAOKI, Kyoto (JP); Shiori UEDA, Kyoto (JP); Takayuki IRIKI, Kyoto (JP); Tatsuya OBE, Kyoto (JP)

(73) Assignee: SHIMADZU CORPORATION, Kyoto (JP)

(21) Appl. No.: 18/969,877

(22) Filed: Dec. 5, 2024

(30) Foreign Application Priority Data
Dec. 15, 2023 (JP) 2023-212169

(51) Int. Cl. G01N 30/86; G01N 30/02; G01N 30/14

(52) U.S. Cl. CPC G01N 30/8624; G01N 30/14; G01N 2030/027

(57) ABSTRACT

A preparative chromatograph system includes: a chromatograph part including a separation column and a detector; a fraction collector for executing a fractionation collecting operation of dropping and collecting the eluate flowed out from the separation column through a nozzle into a plurality of collection containers; a controller configured to control an operation of the fraction collector based on a preset fractionation collecting condition; an information processing device configured to perform information processing relating to the fractionation collecting operation; and a display. The information processing device is configured to output a chromatogram created based on a signal of the detector to the display in a state where fractionated sections on the chromatogram collected in the plurality of collection containers by the fraction collector and collection information including a collection purpose for which each fractionation section has been collected are added to the chromatogram.

### BACKGROUND OF THE INVENTION

### 1. Field of the Invention

The present invention relates to a preparative chromatograph system.

### 2. Description of the Related Art

A preparative chromatograph system is known in which a plurality of components contained in a sample are separated from each other using a chromatograph such as a high-performance liquid chromatograph, and portions respectively containing components in an eluate from a separation column is collected into individual collection containers (see JP 2022-159747 A).

The automatic fractionation collecting using the preparative chromatograph system includes fractionation collecting with waveform processing and fractionation collecting with a time program. In the fractionation collecting with waveform processing, the peak of a component appearing in the chromatogram obtained by a chromatograph is detected under preset conditions, and the operation of a fraction collector is controlled such that the portions detected as peaks on the chromatogram in the eluate from the separation column are sequentially collected into individual collection containers. In the fractionation collecting with a time program, the operation of the fraction collector is controlled based on the time program set such that a desired peak portion is fractionated and collected on the chromatogram acquired in advance for the sample.

### SUMMARY OF THE INVENTION

In the preparative chromatograph system, after the automatic fractionation collecting as described above is executed, fractionation collecting result information indicating which fractionation section on the chromatogram (section on the chromatogram corresponding to the portion of the eluate collected in the collection container) is collected in which collection container is presented to the user. However, in the fractionation collecting result information presented to the user by the conventional system, it has not been possible to easily grasp which fractionation section on the chromatogram has been collected in the collection container for what purpose. Thus, for example, when a certain portion on the chromatogram is dropped to the collection container to purge the inside of the nozzle of the fraction collector, it is not easy to distinguish whether the fractionated sections is dropped to the collection container for purging or collected in the collection container because of erroneous detection as a peak only by taking a look at the analysis result.

The present invention has been made in view of the above problem, and an object of the present invention is to enable the user to easily recognize that for what purpose each fractionation section on a chromatogram collected in a collection container has been collected based on fractionation result information presented after completion of the fractionation collecting of a sample.

A preparative chromatograph system according to the present invention includes:
a chromatograph part including a separation column for separating components contained in a sample from each other and a detector fluidly connected to a downstream of the separation column to output a signal based on a component concentration of an eluate from the separation column;
a fraction collector including a plurality of collection containers, the fraction collector being for executing a fractionation collecting operation of dropping and collecting, at a downstream of the chromatograph part, the eluate flowed out from the separation column through a nozzle into the plurality of collection containers;
a controller configured to control an operation of the fraction collector based on a preset fractionation collecting condition;
an information processing device configured to perform information processing relating to the fractionation collecting operation of the fraction collector; and
a display for displaying information output from the information processing device,
wherein the information processing device is configured to output a chromatogram created based on a signal of the detector of the chromatograph part to the display in a state where fractionated sections on the chromatogram collected in the plurality of collection containers by the fraction collector and collection information including a collection purpose for which each fractionation section has been collected are added to the chromatogram.

According to the preparative chromatograph system of the present invention, the chromatogram to which the fractionated sections on the chromatogram collected in the plurality of collection containers by the fraction collector and the collection information including the collection purpose for which each fractionated sections is collected are added is output to the display. Thus, the user can easily recognize that for what purpose each fractionation section on the chromatogram collected in the collection container has been collected.

### BRIEF DESCRIPTION OF THE DRAWINGS

FIG. 1 is a schematic configuration diagram illustrating an embodiment of a preparative chromatograph system;

FIG. 2 is a diagram illustrating an example of fractionation collecting result information shown on a display in the embodiment; and

FIG. 3 is a flowchart illustrating an operation of the embodiment.

### DETAILED DESCRIPTION OF THE INVENTION

Hereinafter, with reference to the drawings

Hereinafter, an embodiment of a preparative chromatograph system according to the present invention will be described.

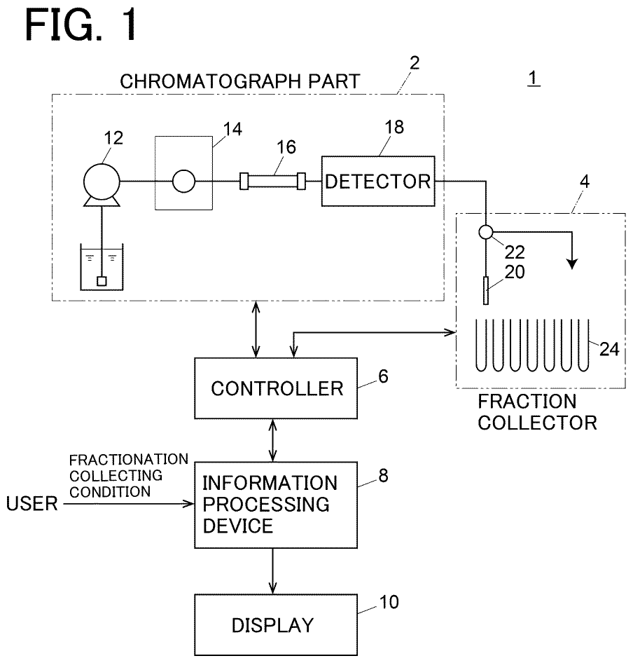

As illustrated in FIG. 1, a preparative chromatograph system 1 includes a chromatograph part 2, a fraction collector 4, a controller 6, an information processing device 8, and a display 10.

The chromatograph part 2 includes a liquid feeding pump 12, an autosampler 14, a separation column 16, and a detector 18. The liquid feeding pump 12 feeds a mobile phase toward the separation column 16. The separation column 16 is for separating a plurality of components in a sample injected into the mobile phase. The autosampler 14 is a device that injects the sample into the mobile phase flowing toward the separation column 16. The detector 18 is provided downstream of the separation column 16, and outputs a signal having an intensity corresponding to the component concentration in an eluate flowed from the separation column 16.

The fraction collector 4 includes a nozzle 20 and a three-way solenoid valve 22. The nozzle 20 can move at least in a horizontal plane direction. The nozzle 20 forms a fluid connection on the downstream side of the detector 18 of the chromatograph part 2. A plurality of collection containers 24 are arrayed in a region within the moving range of the nozzle 20, and the nozzle 20 can be positioned above any collection container 24 to drop the eluate from the separation column 16. The three-way solenoid valve 22 is provided upstream of the nozzle 20, to switch and guide the eluate having passed through the detector 18 to either the nozzle 22 or the drain.

The controller 6 controls the operations of the chromatograph part 2 and the fraction collector 4 based on a fractionation collecting condition given from the information processing device 8 described later. The controller 6 is a device including an electronic circuit including a central processing part (CPU) and an information storage memory.

The information processing device 8 is a computer device for performing various types of information processing. For the information processing device 8, fractionation collecting conditions are set by the user so that the fractions of the eluate containing desired components in the sample are each collected in the collection container 24. The fractionation collecting conditions include the flow rate of the mobile phase, the sample injection amount, the temperature of the separation column 16 and the collection conditions of the fraction collector 4. The collection conditions of the fraction collector 4 are conditions for determining the timing of collecting by dropping the eluate through the nozzle 20 to the collection container 24, including a peak detection condition for detecting a peak appearing in the chromatogram when fractionation collecting with waveform processing of the chromatogram is executed, and a time program for collecting a desired component in each collection container 24 when fractionation collecting with the time program is executed. Further, the collection conditions of the fraction collector 4 also include a purge time for purging the nozzle 20, which is executed after the portion of the eluate corresponding to the peak portion appearing in the chromatogram is collected.

The information processing device 8 gives the fractionation collecting condition set by the user to the controller 6. The controller 6 controls the operations of the chromatograph part 2 and the fraction collector 4 based on information relating to the fractionation collecting condition given from the information processing device 8 and sequentially collects the fractions of the eluate from the separation column 16 in the collection containers 24.

Every time a portion of the eluate is collected into the collection container 24, the controller 6 transmits, to the information processing device 8, the retention time of the fractionated sections on the chromatogram corresponding to the portion of the eluate collected in the collection container 24, collection information including the purpose of collecting the fractionated sections, and identification information of the collection container 24 in which the fractionated sections has been collected. The purpose of collecting the fractionated sections is information indicating whether the fractionated sections is collected in the collection container 24 as a collection target portion (peak portion on chromatogram) of the eluate from the separation column 16 or is collected in the collection container 24 as a non-collection target portion that is not a collection target portion. The fractionated sections to be the non-collection target portion is, for example, fractionated sections only dropped to an empty collection container 24 for purging the nozzle 20.

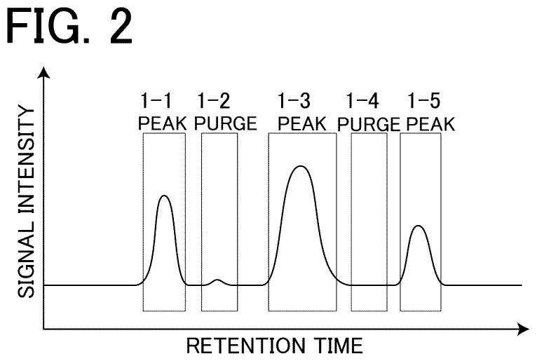

The information processing device 8 creates a chromatogram of the sample based on the output signal from the detector 18 read via the controller 6, and adds the fractionated sections collected in the collection container 24 and the collection information of each fractionation section to the created chromatogram based on the collection information received from the controller 6. In this manner, as illustrated in FIG. 2, the information processing device 8 creates fractionation collecting result information in which the collection information for each fractionation section collected in the collection container 24 is added to the chromatogram.

The display 10 is a device communicably connected to the information processing device 8 for displaying information output from the information processing device 8. After creating the fractionation collecting result information, the information processing device 8 outputs the created fractionation collecting result information to the display 10 in response to a request from the user or automatically, and presents the fractionation collecting result information to the user through the display 10.

In the fractionation collecting result information of FIG. 2, the fractionated sections respectively collected in the collection containers 24 are shown on the chromatogram. 1-1, 1-2, 1-3, 1-4, and 1-5 added to respective fractionated sections are identification information (for example, a number indicating a place where the collection container 24 is set in the fraction collector 4) of the collection containers 24 in which the respective fractionated sections are collected. The fractionated sections collected in the collection containers 24 of 1-1, 1-3, and 1-5 are shown to be peak portions, and the fractionated sections collected in the collection containers 24 of 1-2 and 1-4 are shown to be fractionated sections only dropped from the nozzles 20 to the respective collection containers 24 of 1-2 and 1-4 for purging the nozzle 20.

The fractionation collecting result information not only indicates in which collection container 24 each fractionation section on the chromatogram is collected, but also indicates a collection purpose indicating for what purpose each fractionated section is collected in this manner. Thus, it is useful for the user who refers to the fractionation collecting result information to verify whether setting of the fractionation collecting condition is appropriate. For example, a noise such as a peak appears in the fractionated section to which the identification information 1-2 of the collection container 24 is attached, but since information indicating that the collection purpose is purge is added, it is possible for the user to easily determine that the noise is not erroneously detected as a peak and collected in the collection container 24 but is the fractionated section dropped in the collection container for the purpose of purge.

In this embodiment, the controller 6 and the information processing device 8 are provided as separate devices, but the controller 6 and the information processing device 8 can also be realized by one computer device.

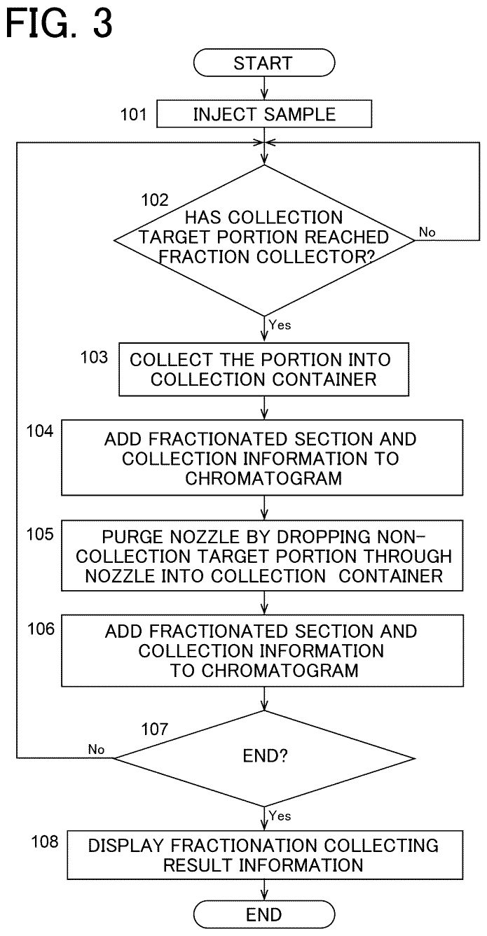

An example of the operation of the preparative chromatograph system 1 will be described by using the flowchart of FIG. 3 together with FIG. 1.

When the user sets a fractionation collecting condition in the information processing device 8 and instructs start of fractionation collecting, the instruction is transmitted from the controller 6 to the chromatograph part 2 and the fraction collector 4, and the autosampler 14 injects a sample into the mobile phase (step 101). When determining that the collection target portion (peak portion) has reached the fraction collector 4 after the sample is injected into the mobile phase, the controller 6 controls the fraction collector 4 such that the collection target portion is collected in an empty collection container 24 (steps 102 and 103). At this time, the controller 6 transmits the collection information of the portion to the information processing device 8. The information processing device 8 indicates, as fractionated section, the section corresponding to the portion of the eluate collected in the collection container 24 in the chromatogram being created, and adds collection information of this fractionated section to the fractionated section (step 104). Here, the notation of “PEAK” indicating that it is collected as a peak portion is added to the corresponding fractionated section on the chromatogram.

Thereafter, the controller 6 moves the nozzle 20 to above a new empty collection container 24 before the portion of the eluate corresponding to the next collection target portion reaches the fraction collector 4, purges the nozzle 20 by dropping the eluate into the collection container 24 for a preset purge time (step 105). At this time as well, the controller 6 transmits the collection information of the portion of the eluate collected in the collection container 24 to the information processing device 8. The information processing device 8 indicates, as fractionated section, the section corresponding to the portion of the collected eluate in the chromatogram being created, and adds collection information of this fractionated section to the fractionated section (step 106). Here, the notation “PURGE” indicating that the fractionated section is collected in the collection container 24 for purging the nozzle 20 is added to the fractionated section.

The above steps 102 to 106 are repeatedly performed until the fractionation collecting of all the collection target components in the sample is completed (or, until a preset fractionation collecting time elapses after the sample is injected). After the fractionation collecting of the sample is completed (step 107), the information processing device 8 outputs the created fractionation collecting result information to the display 10 and presents the fractionation collecting result information to the user through the display 10. The collection information indicating each purpose of collecting the fractionated sections is indicated by “PEAK”, “PURGE”, and the like, but the information may be indicated by symbols (○ and Δ) indicating peak and purge, or may be indicated by color coding for each collection information indicating the purpose of collecting the fractionated section.

The embodiment described above is merely an example of the embodiments of the preparative chromatograph system according to the present invention, and the embodiments of the preparative chromatograph system according to the present invention are as follows.

An embodiment of a preparative chromatograph system according to the present invention includes:
a chromatograph part including a separation column for separating components contained in a sample from each other and a detector fluidly connected to a downstream of the separation column to output a signal based on a component concentration of an eluate from the separation column;
a fraction collector including a plurality of collection containers, the fraction collector being for executing a fractionation collecting operation of dropping and collecting, at a downstream of the chromatograph part, the eluate flowed out from the separation column through a nozzle into the plurality of collection containers;
a controller configured to control an operation of the fraction collector based on a preset fractionation collecting condition;
an information processing device configured to perform information processing relating to the fractionation collecting operation of the fraction collector; and
a display for displaying information output from the information processing device,
wherein the information processing device is configured to output a chromatogram created based on a signal of the detector of the chromatograph part to the display in a state where fractionated sections on the chromatogram collected in the plurality of collection containers by the fraction collector and collection information including a collection purpose for which each fractionation section has been collected are added to the chromatogram.

In a first aspect of the above embodiment, the controller is configured to collect a collection target portion containing a component to be collected in the eluate flowed out from the separation column and non-collection target portion that is not the collection target portion in the eluate flowed out from the separation column into collection containers among the plurality of collection containers individually, and
the collection information includes information for distinguishing whether each of the fractionated sections on the chromatogram are fractionated section corresponding to the collection target portion or fractionated section corresponding to the non-collection target portion.

In the first aspect, the non-collection target portion may be the eluate dropped through the nozzle to a collection container among the plurality of collection container for purging an inside of the nozzle of the fraction collector.

In the above case, the collection information can include identification information of each of the collection containers in which the fractionated sections are collected.

### DESCRIPTION OF REFERENCE SIGNS

1 preparative chromatograph system
2 chromatograph part
4 fraction collector
6 controller
8 information processing device
10 display
12 liquid feeding pump
14 autosampler
16 separation column
18 detector
20 nozzle
22 three-way solenoid valve
24 fraction collector

What is claimed is:

1. A preparative chromatograph system comprising:
a chromatograph part including a separation column for separating components contained in a sample from each other and a detector fluidly connected to a downstream of the separation column to output a signal based on a component concentration of an eluate from the separation column;
a fraction collector including a plurality of collection containers, the fraction collector being for executing a fractionation collecting operation of dropping and collecting, at a downstream of the chromatograph part, the eluate flowed out from the separation column through a nozzle into the plurality of collection containers;
a controller configured to control an operation of the fraction collector based on a preset fractionation collecting condition;
an information processing device configured to perform information processing relating to the fractionation collecting operation of the fraction collector; and
a display for displaying information output from the information processing device,
wherein the information processing device is configured to output a chromatogram created based on a signal of the detector of the chromatograph part to the display in a state where fractionated sections on the chromatogram collected in the plurality of collection containers by the fraction collector and collection information including a collection purpose for which each fractionation section has been collected are added to the chromatogram.

2. The preparative chromatograph system according to claim 1, wherein
the controller is configured to collect a collection target portion containing a component to be collected in the eluate flowed out from the separation column and non-collection target portion that is not the collection target portion in the eluate flowed out from the separation column into collection containers among the plurality of collection containers individually, and
the collection information includes information for distinguishing whether each of the fractionated sections on the chromatogram are fractionated section corresponding to the collection target portion or fractionated section corresponding to the non-collection target portion.

3. The preparative chromatograph system according to claim 2, wherein the non-collection target portion is the eluate dropped through the nozzle to a collection container among the plurality of the collection container for purging an inside of the nozzle of the fraction collector.

4. The preparative chromatograph system according to claim 2, wherein the collection information includes identification information of each of the collection containers in which the fractionated sections are collected.
